(19) United States
(12) Patent Application Publication
(10) Pub. No.: US 2004/0205604 A1
(43) Pub. Date: Oct. 14, 2004

(54) Data driven web page generator

(76) Inventor: Kimberly K. Read, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/970,973

(22) Filed: Oct. 5, 2001

(51) Int. Cl. G06F 17/21

(52) U.S. Cl. 715/517; 715/513

(57) ABSTRACT

A method of and apparatus for data driven web page creation is described. The method includes presenting a first screen for receiving attribute category information, present a second screen for receiving attribute group information, presenting a third screen for receiving attribute information, presenting a fourth screen for receiving attribute to attribute group association information, and creating a web page using the attribute category, attribute group, attribute, and attribute to attribute group association information.

### FIELD OF THE INVENTION

The present invention relates generally to a web page creation and modification mechanism, and more particularly, to a data driven web page creation and modification mechanism.

### BACKGROUND ART

The World Wide Web (WWW) is a subset of Internet functionality that locally and remotely links documents. The web document, i.e., the web page, includes text, graphics, animations and videos as well as hypertext links to other web pages enabling users to jump from page to page (hypertext) whether the pages are stored on the same server or on servers around the world.

In recent years, the WWW has become the focal point of Internet activity by providing an easy, point and click interface to a large collection of online information increasing at a staggering rate.

The WWW includes sites for online shopping from many organizations having e-commerce capabilities. In addition, the WWW includes multimedia delivery systems as new browsers feature extensions enabling audio, video, telephony, 3-D animations and videoconferencing.

The fundamental WWW format is a text document embedded with HTML tags providing the formatting of the page as well as hypertext links to other pages in the form of uniform resource locators (URLs). HTML tags or codes are common alphanumeric characters entered using any text editor or word processor. Numerous WWW publishing programs include a graphical user interface (GUI) for web page creation and generation of the HTML codes.

Web pages are stored at computers supporting the hyper-text transfer protocol (HTTP). Larger organizations or businesses have support staff to create and manage their web sites, while smaller entities have their sites hosted on computers run by their Internet service providers (ISPs).

It is known in the art to create web pages by hand, i.e., to program or generate the text and layout of a web page using, at a minimum, a text editor. Advances in web page creation include template-based creation in which a form layout is used and filled in to create an individual web page. However, even under both of these approaches, it is necessary that an individual have some knowledge of the hyper-text markup language in order to create the web page. Thus, there is a need in the art to enable the generation of web pages without requiring knowledge of HTML because a business owner, typically having little or no computer skills, would then be able to create and maintain the business' web pages.

By enabling the business owner to create their own web pages, the owner is enabled to take control of the design, creation, and maintenance of the web site and to not have to rely on outside persons for web site related matters. This may also result in cost savings because additional persons need not be hired specifically for web page efforts. Thus, there is a need in the art to enable a business owner to take control of their web site.

With template-based or other web page generation mechanisms it is necessary to “recompile” the web page, i.e., the web page needs to be regenerated or recreated, after changes are made. If the user forgets to recompile the web page, any changes made will not be updated on the viewable or published web site. Therefore, there is a need in the art for a web page generation mechanism which does not require recompilation after changes are made.

### DISCLOSURE/SUMMARY OF THE INVENTION

It is therefore an object of the present invention to provide a web page generation mechanism not requiring recompilation after changes are made to the web page.

Another object of the present invention is to enable users to generate web pages without requiring knowledge of HTML.

Another object of the present invention is to enable a user to more easily control web site content.

The above described objects are fulfilled by a method of and apparatus for data driven web page creation. A method aspect includes presenting a first screen for receiving attribute category information, presenting a second screen for receiving attribute group information, presenting a third screen for receiving attribute information, presenting a fourth screen for receiving attribute to attribute group association information, and creating a web page using the attribute category, attribute group, attribute, and attribute to attribute group association information.

An apparatus aspect includes a processor for receiving and transmitting data and a memory coupled to the processor. The memory has stored sequences of instructions which, when executed by the processor, cause the processor to present a first screen for receiving attribute category information, present a second screen for receiving attribute group information, present a third screen for receiving attribute information, present a fourth screen for receiving attribute to attribute group association information, and create a web page using the attribute category, attribute group, attribute, and attribute to attribute group association information.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a block diagram of a computer system used in an embodiment of the present invention;

FIG. 2 is an example web page generated from an embodiment of the present invention;

FIG. 3 is a user interface window for entering attribute category information according to an embodiment of the present invention;

FIG. 4 is a user interface window for entering attribute group information according to an embodiment of the present invention;

FIG. 5 is a user interface window for entering attribute update information according to an embodiment of the present invention; and

FIG. 6 is a user interface window for entering attribute group association information according to an embodiment of the present invention.

### BEST MODE FOR CARRYING OUT THE INVENTION

A method and apparatus for a data driven web page creation mechanism are described. In the following description, for purposes of explanation, numerous specific details are set forth in order to provide a thorough understanding of the present invention. It will be apparent; however, that the present invention may be practiced without these specific details. In other instances, well-known structures and devices are shown in block diagram form in order to avoid unnecessarily obscuring the present invention.

### Top Level Description

The data driven web page generator is a software program including several screens allowing a user or business owner to define the presentation of information to other users, e.g., customers. Typically, the presentation is in the form of one or more HTML documents. The business owner defines attribute categories or subject areas and specifies the number of columns to be used in a table and the orientation of the table, e.g., horizontal or vertical. The business owner specifies the attribute group information and attribute information. The business owner further specifies the attribute groups associated with each attribute category and the location of an attribute group on a page. Finally, the business owner specifies the attributes and associates the specified attributes with an attribute group. The web page is created by the business owner without requiring a web developer and/or programmer. The business owner modifies the web page as the business changes.

### DETAILED DESCRIPTION

### Hardware Overview

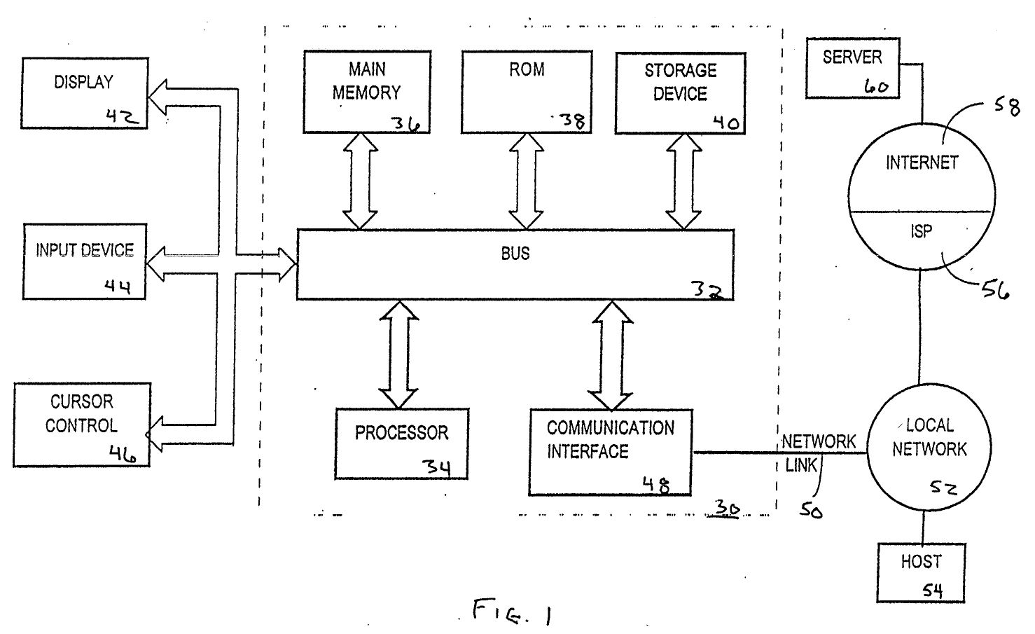

FIG. 1 is a block diagram illustrating an exemplary computer system 30 upon which an embodiment of the invention may be implemented. The present invention is usable with currently available personal computers, mini-mainframes, enterprise servers, multiprocessor computers and the like.

Computer system 30 includes a bus 32 or other communication mechanism for communicating information, and a processor 34 coupled with the bus 32 for processing information. Computer system 30 also includes a main memory 36, such as a random access memory (RAM) or other dynamic storage device, coupled to the bus 32 for storing information and instructions to be executed by processor 34. Main memory 36 also may be used for storing temporary variables or other intermediate information during execution of instructions to be executed by processor 34. Computer system 30 further includes a read only memory (ROM) 38 or other static storage device coupled to the bus 32 for storing static information and instructions for the processor 34. A storage device 40, such as a magnetic disk or optical disk, is provided and coupled to the bus 32 for storing information and instructions.

Computer system 30 may be coupled via the bus 32 to a display 42, such as a cathode ray tube (CRT) or a flat panel display, for displaying information to a computer user. An input device 44, including alphanumeric and other keys, is coupled to the bus 32 for communicating information and command selections to the processor 34. Another type of user input device is cursor control 46, such as a mouse, a trackball, or cursor direction keys for communicating direction information and command selections to processor 34 and for controlling cursor movement on the display 42. This input device typically has two degrees of freedom in two axes, a first axis (e.g., x) and a second axis (e.g., y) allowing the device to specify positions in a plane.

The invention is related to the use of a computer system 30, such as the illustrated system, to provide a data driven web page generator and method of use thereof. According to one embodiment of the invention, a data driven web page generator is provided by computer system 30 in response to processor 34 executing sequences of instructions contained in main memory 36. Such instructions may be read into main memory 36 from another computer-readable medium, such as storage device 40. However, the computer-readable medium is not limited to devices such as storage device 40.

For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 36 causes the processor 34 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 30 also includes a communication interface 48 coupled to the bus 32. Communication interface 48 provides a two-way data communication as is known. For example, communication interface 48 may be an integrated services digital network (ISDN) card, a digital subscriber line (DSL), or a modem to provide a data communication connection to a corresponding type of telephone line. As another example, communication interface 48 may be a local area network (LAN) card to provide a data communication connection to a compatible LAN. Wireless links may also be implemented. In any such implementation, communication interface 48 sends and receives electrical, electromagnetic or optical signals which carry digital data streams representing various types of information. Of particular note, the communications through interface 48 may permit transmission or receipt of the web page generating data and pages. For example, two or more computer systems 30 may be networked together in a conventional manner with each using the communication interface 48.

Network link 50 typically provides data communication through one or more networks to other data devices. For example, network link 50 may provide a connection through local network 52 to a host computer 54 or to data equipment operated by an Internet Service Provider (ISP) 56. ISP 56 in turn provides data communication services through the world wide packet data communication services through the world wide packet data communication network now commonly referred to as the “Internet” 58. Local network 52 and Internet 58 both use electrical, electromagnetic or optical signals which carry digital data streams. The signals through the various networks and the signals on network link 50 and through communication interface 48, which carry the digital data to and from computer system 30, are exemplary forms of carrier waves transporting the information.

Computer system 30 can send messages and receive data, including program code, through the network(s), network link 50 and communication interface 48. In the Internet example, a server 60 might transmit a requested code for an application program through Internet 58, ISP 56, local network 52 and communication interface 48. In accordance with the invention, one such downloaded application provides for a data driven web page generator and method of use thereof, as described herein.

The received code may be executed by processor 34 as it is received, and/or stored in storage device 40, or other non-volatile storage for later execution. In this manner, computer system 30 may obtain application code in the form of a carrier wave.

### Functional

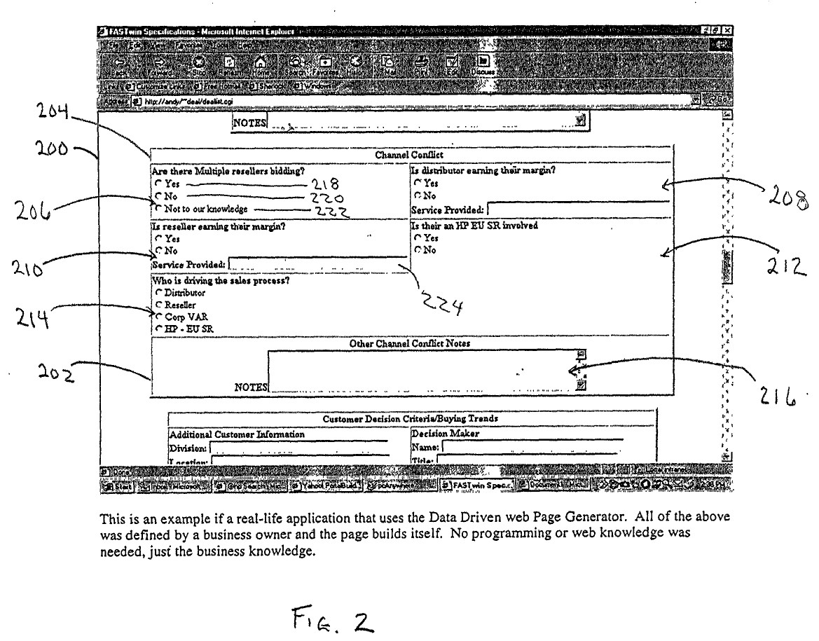

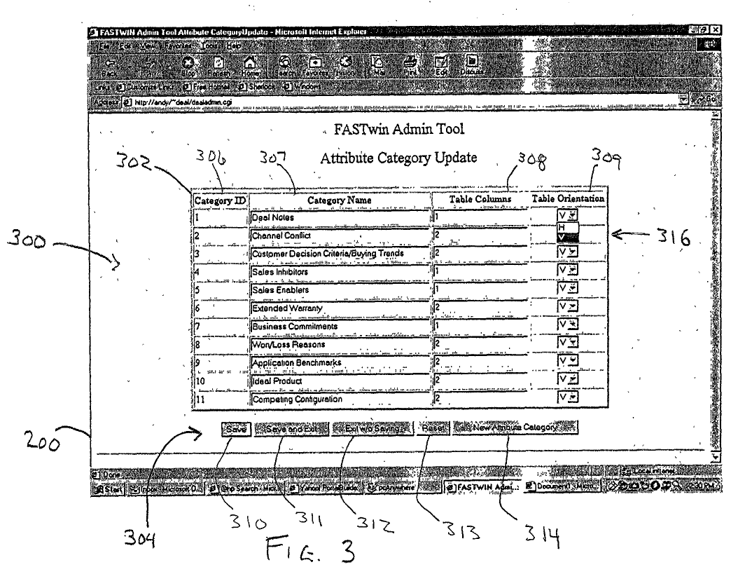

FIG. 2 is a representative portion of a web page produced by the data driven web page generator as viewed in a web browser window 200 on a computer system 30. Browser window 200 includes an attribute category table 202, i.e., the channel conflict category, which is a portion of a web page for a business owner. The business owner's web page includes multiple attribute categories (described in detail below with reference to FIG. 3) for presenting and/or obtaining information from a user or visitor to the web site.

Each attribute category is displayed as a table having rows and columns and wherein the table elements, i.e., intersection of a row and column, are attribute groups within an attribute category. The table may have one or more rows and columns and may be oriented horizontally or vertically, e.g., attribute category table 202 is a table having five rows and two columns. The first row 204 includes the attribute category title and spans both columns.

Attribute category table 202 has six attribute groups 206-216, respectively multiple reseller group 206, distributor earning group 208, reseller earning group 210, HP EU SR group 212, sales process driver group 214, and notes group 216. Each attribute group includes individual attributes displayed within the attribute group's table element, e.g., attribute group 206 includes yes attribute 218, no attribute 220, and no knowledge attribute 222. Each attribute includes an attribute type, described in detail below, defining how each attribute is to be displayed, e.g., yes attribute 218 is a radio button type attribute and service provided attribute 224 in attribute group 210 is a text type attribute.

Each attribute, attribute group, and attribute category is specified by the user and is used to generate the web page viewed by a user, e.g., the web page viewed in browser window 200. Next, the detailed data provided by a user for the generation of the web page is described.

With reference to FIG. 3, an attribute category update screen 300 is displayed within a browser window 200. Category update screen 300 includes an attribute category update table 302 for specifying attribute category information and a button control area 304 for commanding the web page generator.

The attribute category update table 302 includes four columns of information pertaining to individual attribute categories, i.e., category ID column 306, category name column 307, table columns number column 308, and table orientation column 309. The category ID column 306 entry is a web page generator supplied value unique for each attribute category and is not set or modifiable by the user. In one embodiment, the category ID column 306 entry is a sequentially incremented value. Other methods for generating the category ID column 306 entry are possible, e.g., non-repeating random values and sequentially increasing or decreasing alpha-numeric values.

The category name column 307 entry is a user-supplied alpha-numeric value specifying the name of an attribute category, e.g., “Deal Notes”, “Channel Conflict”, “Customer Decision Criteria/Buying Trends”, and “Sales Inhibitors”. The table columns number column 308 entry is a user-specified integer value specifying the number of columns used by an attribute category, e.g., the attribute category having a category ID value of two, that is, the Channel Conflict attribute category, has two columns for containing attribute groups. The table orientation column 309 entry is a user-specified value specifying the orientation of the attribute category table, e.g., horizontal or vertical orientation.

Thus, comparing the row entry corresponding to the category ID having a value of two with the attribute category table 202 of FIG. 2, it can be seen that the attribute category table 202 (a) has a title 204 matching the category name column 307 value of “Channel Conflict”, (b) has two columns, and (c) the table is vertically oriented according to the table orientation column 309 specification.

The button control area 304 includes buttons manipulable by the user to command the web page generator, namely save button 310, save and exit button 311, exit without saving button 312, reset button 313, and new attribute category button 314. Activating save button 310 saves user changes of attribute category update information to main memory 36 or storage device 40. Activating save and exit button 311 saves user changes of attribute category update information to main memory 36 or storage device 40 and exits the web page generator. Activating the exit without saving button 312 exits the web page generator without saving any user changes of attribute category update information. Activating the reset button 313 discards any user changes of attribute category update information and reverts the values to the previously saved values. Activating the new attribute category button 314 commands the web page generator to add an additional attribute category to the attribute category update table 302 and generate a unique category ID value for the new attribute category.

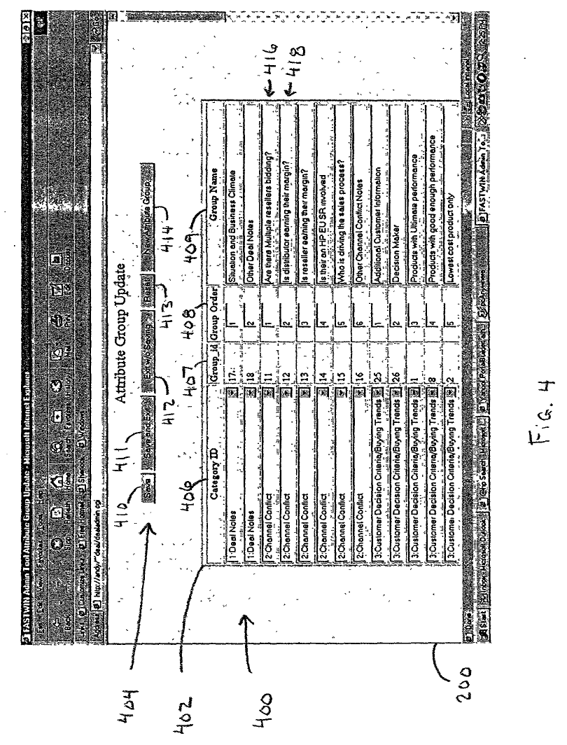

As described above in conjunction with FIG. 2, each attribute category includes an attribute group and the attribute group is specified using an attribute group update screen 400, as shown in FIG. 4. The attribute group update screen 400 is similar in form to the attribute category update screen 300, described above, in that the screen 400 includes an attribute group update table 402 and a button control area 404.

The attribute group update table 402 includes four columns of information pertaining to individual attribute groups, i.e., category ID column 406, group ID column 407, group order column 408, and group name column 409. The category ID column 406 entry is a user-selectable value list based on the user value entries in category name column 307 of FIG. 3. The group ID column 407 entry is a web page generator supplied value unique for each group category and is not set or modifiable by the user. In one embodiment, the group ID column 407 entry is a sequentially incremented value. Other methods for generating the group ID column 407 entry are possible, e.g., non-repeating random values and sequentially increasing or decreasing alpha-numeric values.

The group order column 408 entry is a user-specified integer value specifying the order in which attribute groups within an attribute category are displayed. For example, attribute group 416 is displayed prior to attribute group 418 because the group order column 408 entry specifies that group 416 is the first group followed by group 418 as the second group.

The group name column 409 entry is a user-supplied alpha-numeric value specifying the name of an attribute group, e.g., “Situation and Business Climate”, “Other Deal Notes”, “Are there Multiple resellers bidding?”, and “Is distributor earning their margin?”.

Thus, comparing the row entry of attribute group 416 corresponding to the category ID having a value of “Channel Conflict” and the group ID having a value of eleven with the attribute group 206 of attribute category table 202 of FIG. 2, it can be seen that the attribute group 206 (a) has a title of “Are there Multiple resellers bidding?” corresponding to the group name column 409 entry and (b) is the first group displayed in the attribute category table 202.

The button control area 404 includes buttons manipulable by the user to command the web page generator, namely save button 410, save and exit button 411, exit without saving button 412, reset button 413, and new attribute group button 414. Activating save button 410 saves user changes of attribute group update information to main memory 36 or storage device 40. Activating save and exit button 411 saves user changes of attribute group update information to main memory 46 or storage device 40 and exits the web page generator. Activating the exit without saving button 412 exits the web page generator without saving any user changes of attribute group update information.

Activating the reset button 413 discards any user changes of attribute group update information and reverts the values to the previously saved values. Activating the new attribute group button 414 commands the web page generator to add an additional attribute group to the attribute group update table 402 and generate a unique group ID value for the new attribute group.

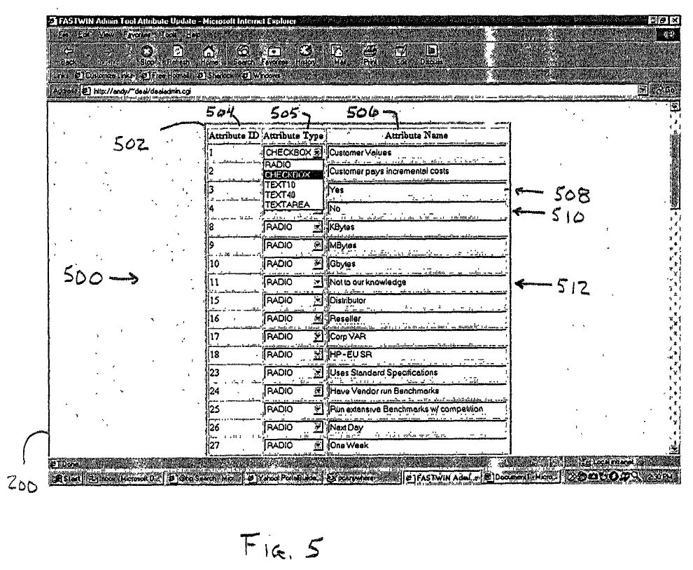

As described above in conjunction with FIG. 2, each attribute group of an attribute category includes individual attributes and the attributes are specified using an attribute update screen 500, as shown in FIG. 5. The attribute update screen 500 is similar in form to the attribute category update screen 300 and the attribute group update screen 400, described above, in that the screen 500 includes an attribute group update table 502 and a button control area (not shown) functionally similar to button control areas 304 and 404.

The attribute update table 502 includes three columns of information pertaining to individual attributes, i.e., attribute ID column 504, attribute type column 505, and attribute name column 506. The attribute ID column 504 entry is a web page generator supplied value unique for each attribute and is not set or modifiable by the user. In one embodiment, the attribute ID column 504 entry is a sequentially incremented value. Other methods for generating the attribute ID column 504 entry are possible, e.g., non-repeating random values and sequentially increasing or decreasing alpha-numeric values. The attribute type column 505 entry is a user-selectable value list based on predefined display elements, e.g., radio buttons, text boxes for receiving ten character input, text boxes for receiving forty character input, checkboxes, and text areas.

The attribute name column 506 entry is a user-specified alpha-numeric value specifying the name of an attribute, e.g., “Customer Values”, “Customer pays incremental costs”, “Yes”, “No”, “KBytes”, “MBytes”, “Gbytes”, and “Not to our knowledge”.

Thus, comparing the row entry of attribute 508 corresponding to the attribute ID having a value of three with the attribute group 206 of attribute category table 202 of FIG. 2, it can be seen that the attribute group 206 has an attribute 218 having a value of yes. Further, no and no knowledge attributes 220 and 222, having radio button display elements, correspond to attributes 510 and 512 of FIG. 5.

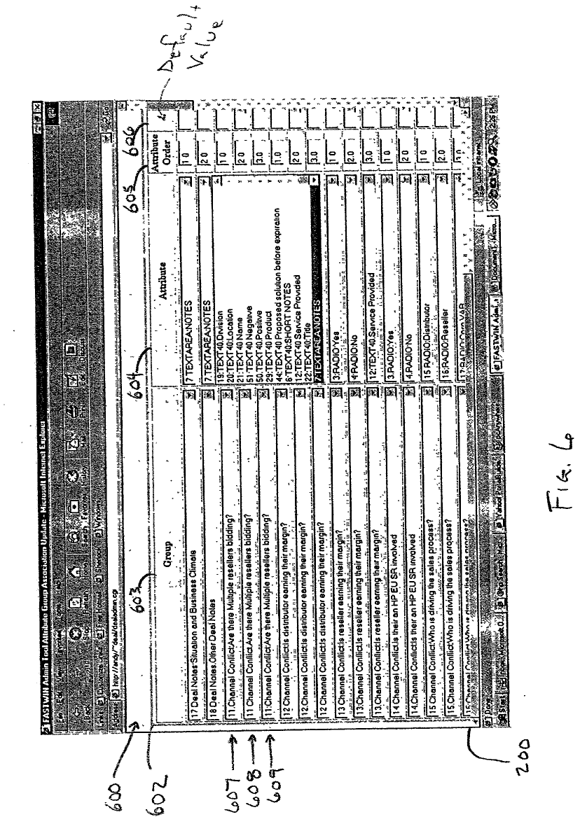

As described above in conjunction with FIG. 2, each attribute group of an attribute category includes individual attributes, the association of attributes with attribute groups is specified using an attribute group association update screen 600, as shown in FIG. 6. The attribute group association update screen 600 is similar in form to the attribute category update screen 300, the attribute group update screen 400, and the attribute update screen 500, described above, in that the screen 600 includes an attribute group update table 602 and a button control area (not shown) functionally similar to button control areas 304 and 404.

The attribute group association update table 602 includes four columns of information pertaining to the association of individual attributes with an attribute group, i.e., group column 603, attribute column 604, attribute order column 605, and default value column 606. The group column 603 entry is a user-selectable value list based on entries in the attribute group update table 402 as specified by a combination of (a) the group ID column 407 entry, (b) the category ID column 406 user selection, and (c) the user value entry in group name column 409 of FIG. 4. The attribute column 604 entry is a user-selectable value list based on entries in the attribute update table 502 as specified by a combination of (a) the attribute ID column 504, (b) the attribute type column 505, and (c) the attribute name column 506.

The attribute order column 605 entry is a user-specified integer value specifying the order in which attributes within an attribute group are displayed, e.g., based on increasing numeric value.

The default value column 606 entry is a user-selectable value specifying whether the corresponding attribute is the default value for the particular attribute group association table 502 entry.

Thus, comparing the row entries of attribute group assocations 607-609 corresponding to the group having a category ID value of eleven, a category name value of “Channel Conflict”, and a group name value of “Are there Multiple resellers bidding?”, the attribute column 604 entries are “3:RADIO:Yes”, “4:RADIO:No”, and “11:RADIO:Not to our knowledge”, respectively row entries 607, 608, and 609. The row entries 607, 608, and 609 are based on row entries 508, 510, and 512 of FIG. 5, i.e., the combination of attribute ID column 504 entry, attribute type column 505 entry, and attribute name column 506 entry.

By adding a group and attribute association to the attribute group association update table 602, a user is adding attributes to the resulting web page displayed to a user, e.g., attribute category table 202 in window 200 of FIG. 2. The web page generator generates the web page based on the data in the attribute group association update table 602 in combination with the attribute update table 502, the attribute group update table 402, and the attribute category update table 302.

For example, the yes attribute 218 is specified by row entry 508 in attribute update table 502 to be a radio button, based on the attribute type column 505 entry, and to have a name of yes, based on the attribute name column 506 entry. The yes attribute 218 is specified as the first attribute in attribute group 206 based on the row entry 607 in attribute group association update table 602 having an attribute order column 605 entry of one. Row entry 607 also specifies through the association of the attribute with the group, through column selections in group column 603 and attribute column 604, that the attribute is to be displayed as part of the attribute group 206.

Row entry 416 in attribute group update table 402 specifies attribute group 206 as the first attribute group in attribute category 204 based on the group order column 408 entry and the category ID column 406 entry. Row entry 316 in attribute category update table 302 specifies attribute category table 202 as having two vertically oriented columns based on the table columns number column 308 entry and the table orientation column 309 entry.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of data driven web page creation comprising the following steps:
presenting a first screen for receiving attribute category information;
presenting a second screen for receiving attribute group information;
presenting a third screen for receiving attribute information;
presenting a fourth screen for receiving attribute to attribute group association information and
creating a web page using the attribute category, attribute group, attribute, and attribute to attribute group association information.

2. The method as claimed in claim 1 wherein the first screen further receives a column specification.

3. The method as claimed in claim 2 wherein the column specification includes the number of columns and column orientation.

4. The method as claimed in claim 1 wherein the attribute category information includes category ID, category name, column number, and table orientation information.

5. The method as claimed in claim 1 wherein the attribute group information includes category ID, group ID, group order, and group name information.

6. The method as claimed in claim 1 wherein the attribute information includes attribute ID, attribute type, and attribute name information.

7. The method as claimed in claim 1 wherein the attribute to attribute group association information includes group, attribute, attribute order, and default value information.

8. A computer system for data driven web page creation comprising:
a processor for receiving and transmitting data; and
a memory coupled to the processor, the memory having stored therein sequences of instructions which, when executed by the processor, cause the processor to present a first screen for receiving attribute category information, present a second screen for receiving attribute group information, present a third screen for receiving attribute information, present a fourth screen for receiving attribute to attribute group association information, and create a web page using the attribute category, attribute group, attribute, and attribute to attribute group association information.

9. The computer system as claimed in claim 8 wherein the attribute category information includes category ID, category name, column number, and table orientation information.

10. The computer system as claimed in claim 8 wherein the attribute group information includes category ID, group ID, group order, and group name information.

11. The computer system as claimed in claim 8 wherein the attribute information includes attribute ID, attribute type, and attribute name information.

12. The computer system as claimed in claim 8 wherein the attribute to attribute group association information includes group, attribute, attribute order, and default value information.
